(19) United States
(12) Patent Application Publication
(10) Pub. No.: US 2026/0203083 A1
(43) Pub. Date: Jul. 16, 2026

(54) METHOD, APPARATUS, DEVICE, AND STORAGE MEDIUM FOR CONTROLLING RUNNING OF APPLICATION PROGRAM

(71) Applicant: Beijing Zitiao Network Technology Co., Ltd., Beijing (CN)

(72) Inventors: Jingbin HUANG, Beijing (CN); Kewei CHEN, Beijing (CN); Yili LI, Beijing (CN)

(21) Appl. No.: 19/136,233

(22) PCT Filed: Nov. 21, 2023
(86) PCT No.: PCT/CN2023/132854

§ 371 Date: Jun. 5, 2025

(30) Foreign Application Priority Data
Dec. 5, 2022 (CN) 202211552513.4

(51) Int. Cl. G06F 9/451; G06F 3/0481

(52) U.S. Cl. CPC G06F 9/452; G06F 3/0481

(57) ABSTRACT

Embodiments of the disclosure provide a method, an apparatus and a device, and a storage medium for controlling running of application program. indication information of an operating system is detected, where a first application program and a second application program run in the operating system, and the indication information indicates an input focus for receiving input information; after the input focus is transferred from the first application program to the second application program, a current application frame rate of the first application program is set as a target application frame rate based on the indication information, where the application frame rate represents an interface refresh rate of an application program, and the target application frame rate is less than the current application frame rate of the first application program.

This application claims priority to the Chinese Patent Application No. 202211552513.4, filed with the Chinese Patent Office on Dec. 5, 2022, and entitled “METHOD, APPARATUS, DEVICE AND STORAGE MEDIUM FOR CONTROLLING RUNNING OF APPLICATION PROGRAM”, which is incorporated herein by reference in its entirety.

### FIELD

Embodiments of the present disclosure relate to the field of computer technologies, and in particular, to a method, apparatus, device, and storage medium for controlling running of application program.

### BACKGROUND

In application fields such as image editing and image post-processing, an image or video is edited by using an image processing application program, so as to achieve an objective of adding a visual effect to the image or video. In this process, preview and display the edited image can be achieved through the application program in real time, so that the operator can observe the effect of image editing in real time, thereby improving the quality and efficiency of the image editing.

However, in an actual application process, a terminal device running an image processing application program needs to run other application programs at the same time, and running of the image processing application program causes problems such as the running of the other application programs being stuck, the smoothness being reduced, and the running speed becoming slower, thereby affecting the normal running of the other application programs.

### SUMMARY

Embodiments of the present disclosure provide a method, apparatus, device, and a storage medium for controlling running of application program, so as to overcome problems caused by running of an image processing application, such as the running of another application being stuck, the smoothness being reduced, and the running speed becoming slower.

According to a first aspect, an embodiment of the present disclosure provides a method for controlling running of application program, including:
detecting indication information of an operating system, a first application program and a second application program running within the operating system, and the indication information indicating an input focus for receiving input information; and after the input focus is transferred from the first application program to the second application program, setting a current application frame rate of the first application program as a target application frame rate based on the indication information, where the application frame rate represents an interface refresh rate of an application program, and the target application frame rate is less than the current application frame rate of the first application program.

According to a second aspect, an embodiment of the present disclosure provides an apparatus for controlling running of application program, including:
a detection module configured to detect indication information of an operating system, a first application program and a second application program running within the operating system, and the indication information indicating an input focus for receiving input information; and
a control module configured to set a current application frame rate of the first application program as a target application frame rate based on the indication information, after the input focus is transferred from the first application program to the second application program, where the application frame rate represents an interface refresh rate of an application program, and the target application frame rate is less than the current application frame rate of the first application program.

According to a third aspect, an embodiment of the present disclosure provides an electronic device, including:
a processor and a memory communicatively connected to the processor;
the memory stores computer execution instructions;
the processor executes the computer execution instructions stored in the memory, so as to implement the method for controlling running of an application program according to the foregoing first aspect and various possible designs of the first aspect.

According to a fourth aspect, an embodiment of the present disclosure provides a computer readable storage medium. The computer readable storage medium stores a computer execution instruction. When executing the computer execution instructions, a processor implements the method for controlling running of an application program according to the first aspect and various possible designs of the first aspect is implemented.

According to a fifth aspect, an embodiment of the present disclosure provides a computer program product, including a computer program. The computer program, when executed by a processor, implements the method for controlling running of an application program according to the foregoing first aspect and various possible designs of the first aspect.

Provided are a method, apparatus, device, and a storage medium for controlling running of an application program. The method includes: detecting indication information of an operating system, a first application program and a second application program running within the operating system, and the indication information indicating an input focus for receiving input information; after the input focus is transferred from the first application program to the second application program, setting a current application frame rate of the first application program as a target application frame rate based on the indication information, where the application frame rate represents an interface refresh rate of an application program, and the target application frame rate is less than the current application frame rate of the first application program. After it is detected that the input focus of the operating system is transferred from the first application program to the second application program, a running parameter of a first application program is configured, so that the first application program runs at a target application frame rate lower than a current application frame rate. In this way, computing resources occupied by the first application program are released, so that the second application program can run by using more sufficient computing resources, thereby improving the smoothness and running speed of a second application program, and reducing the program lagging.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description describe some embodiments of the present disclosure. For those skilled in the art, other drawings may also be obtained according to these drawings without creative efforts.

FIG. 1 is an application scenario diagram of a method for controlling running of an application program according to an embodiment of the present disclosure;

FIG. 2 is a first schematic flowchart of a method for controlling running of an application program according to an embodiment of the present disclosure;

FIG. 3 is a flowchart of a specific implementation manner of step S102 in the embodiment shown in FIG. 2:

FIG. 4 is a schematic diagram of a process for determining a target application frame rate according to an embodiment of the present disclosure;

FIG. 5 is a flowchart of a specific implementation of step S103 in the embodiment shown in FIG. 2;

FIG. 6 is a schematic diagram of a video playing process according to an embodiment of the present disclosure;

FIG. 7 is a flowchart of a specific implementation of step S1031 in the embodiment shown in FIG. 5;

FIG. 8 is a flowchart of a specific implementation of step S1032 in the embodiment shown in FIG. 5;

FIG. 9 is a schematic diagram of a process of pausing an application function according to an embodiment of the present disclosure;

FIG. 10 is a second schematic flowchart of a method for controlling running of an application program according to an embodiment of the present disclosure;

FIG. 11 is a schematic diagram of creating a first window according to an embodiment of the present disclosure;

FIG. 12 is a structural block diagram of an apparatus for controlling running of an application program according to an embodiment of the present disclosure;

FIG. 13 is a schematic structural diagram of an electronic device according to an embodiment of the present disclosure;

FIG. 14 is a schematic structural diagram of hardware of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings related to the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the scope of protection of the present disclosure.

It should be noted that, the user information (including but not limited to information of user device, user personal information, and the like) and data (including but not limited to data used for analysis, stored data, displayed data, and the like) involved in the present application are: information and data which are authorized by a user or sufficiently authorized by each party, and collection, use and processing of relevant data need to comply with relevant legal regulations and standards of relevant countries and regions, A corresponding operation entry is provided for the user to select authorization or rejection.

Application scenarios of the embodiments of the present disclosure will be explained below:

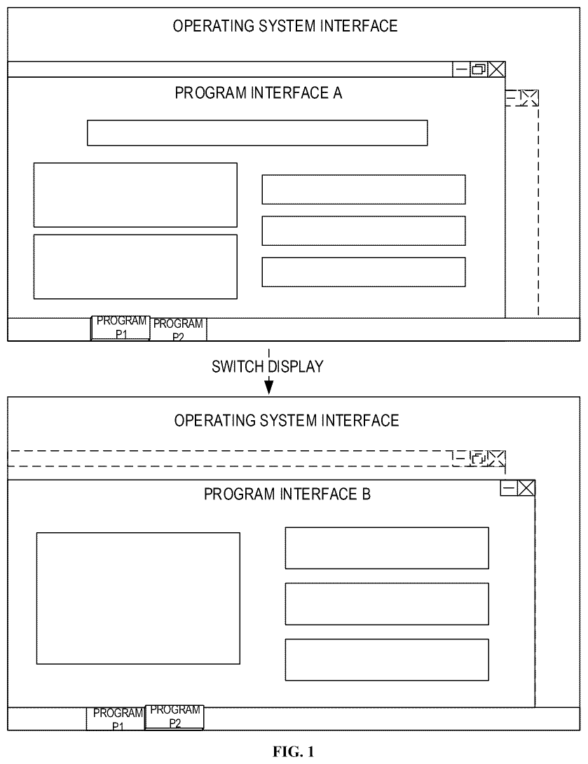

FIG. 1 is an application scenario diagram of a method for controlling running of an application program provided by an embodiment of the present disclosure. The method for controlling running of an application program provided by the embodiment of the present disclosure can be applied to an application scenario in which a plurality of applications run synchronously, more specifically, such as an application scenario of image editing and video effect production. As shown in FIG. 1, the method provided in the embodiment of the present disclosure may be applied to a terminal device such as a personal computer. In an application scenario that require synchronous running of a plurality of programs, such as image editing and video specialty production, another program (such as, a browser program) may run in a background running manner while an image editing program is running in an operating system of a terminal device. In an actual running process, when a terminal device displays a program interface (which is shown as a program interface A in the drawing) of an image editing program (which is shown as a program P1 in the drawing) on the uppermost layer of an operating system interface, the program interface of the image editing program has an input focus, and an operation on the image editing program can be realized through input information in response to the input by a user. After receiving the switching operation input by the user, the terminal device switches and displays the image editing program and the browser program, a program interface (shown as a program interface B in the drawing) of the browser program (shown as a program P2 in the drawing) is displayed on the uppermost layer of the operating system interface, In this case, the program interface of the browser program has an input focus, and then an operation on the image editing program can be realized through input information in response to the input by a user. In this way, synchronous running and coordination work among a plurality of programs is implemented, for example, copying a picture in a browser program to an image editing program through a clipboard.

In the prior art, taking a graphic editing program as an example, the graphic editing program may preview and display an edited image in real time, so that an operator can observe an effect of image editing in real time, thereby improving the quality and efficiency of image editing. This process needs to occupy a large amount of computing resources of the terminal device to perform real-time image rendering, thus, the occupancy rate for computing resources of the terminal device is relatively high, and in this case, when the user needs to switch to another program, such as, the browser program shown in FIG. 1, problems may be caused due to insufficient system resources, such as the browser program being stuck and the running speed being slower, and thus affecting normal operation of the browser program. An embodiment of the present disclosure provides a method for controlling running of an application program to solve the above problem.

Referring to FIG. 2, FIG. 2 is a first schematic flowchart of a method for controlling running of an application program according to an embodiment of the present disclosure. The method in this embodiment may be applied to a terminal device, and the method or controlling running of an application program includes:

At step S101, indication information of an operating system is detected, a first application program and a second application program running within the operating system, and the indication information indicating an input focus for receiving input information.

By way of example, an execution body of the method for controlling running of an application program provided in this embodiment is a terminal device, such as a personal computer or a tablet computer. An operating system, such as a Windows operating system and an Android operating system, is installed in the terminal device, and based on the operating system, a corresponding application program runs in the operating system. At least a first application program and a second application program run in an operating system of a terminal device. The first application program and the second application program respectively have a program interface that can be displayed within the operating system interface. For details, reference may be made to the image editing program and the browser program shown in FIG. 1. Certainly, it can be understood that the first application program and the second application program may also be other application programs, for example, a file management program, another image editing program, or a program built in an operating system, which are not repeatedly described herein by way of example, and the first application program and the second application program may be configured according to a requirement.

Further, an operating system can generate indication information, and the indication information is configured for indicating an input focus for receiving the input information. In a specific implementation, the indication information is a focus (Focus) within an operating system interface, and is used for indicating a program and a component for receiving the input information. The focus is also referred to as an input focus. In an operating system interface, a program interface generally having an input focus is displayed on an uppermost layer of the operating system interface. When the program interface of an application program has an input focus, input information can be received through a man-machine interface of the terminal device, thereby implementing an operation on the application program having the input focus.

More specifically, taking a Windows operating system as an example, the Windows operating system is a message-oriented system, an application program can only passively wait for a message entered through keys pressed by a user, and it cannot actively read the state of a keyboard, That is to say, whenever a key is pressed on the keyboard, the operating system will send a key message to the window, telling it that a certain key has been pressed, and as soon as the mouse moves, the system will also send a corresponding message, and transmit coordinate information of the mouse to the window. The Windows operating system can execute many programs at the same time, and this problem can be solved by adopting an input focus. By way of example, for example, when a certain interface or window obtains an input focus, the input focus will not only be lifted to the uppermost layer of the screen, but also have different colors, all keyboard messages will be directed to the window, and the interface or window also becomes an “active window”.

Further, by way of example, after the application program runs, the operating system assigns an input focus to a program interface of a running program currently running in the foreground, and correspondingly, when the input focus changes, the operating system also tracks the input focus to obtain a corresponding window pointer. In different operating systems, methods for detecting an input focus are different, but specific implementations are known to persons skilled in the art, and are not described herein again.

At step S102, after the input focus is transferred from the first application program to the second application program, a current application frame rate of a first application program is set as a target application frame rate according to indication information, where the application frame rate represents an interface refresh rate of an application program, and the target application frame rate is less than the current application frame rate of the first application program.

By way of example, according to the input focus represented by the indication information, when it is detected that the input focus is transferred from the first application program to the second application program, it indicates that the input focus is transferred, that is, the user switches the first application program from “foreground running” to “background running”, and switches the second application program from “background running” to “foreground running”. In this case, the application frame rate of the first application program switched to the background is adjusted, and the current operating frame rate is reduced to the target operating frame rate. For example, in a case in which the first application program is running in a normal foreground (having an input focus), a normal application frame rate is 30 Hertz (Hz), that is, the interface refresh rate of the first application program is 30 Hz, when the first application program is switched to running in the background (the input focus is lost), the application frequency of the first application program is set as 1 hertz (Hz), that is, the interface refresh rate of the first application program is 1 Hz, thereby reducing the overhead of computing resources required for displaying the interface of the first application program.

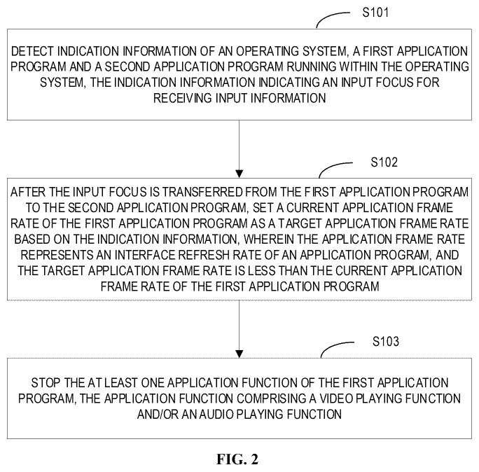

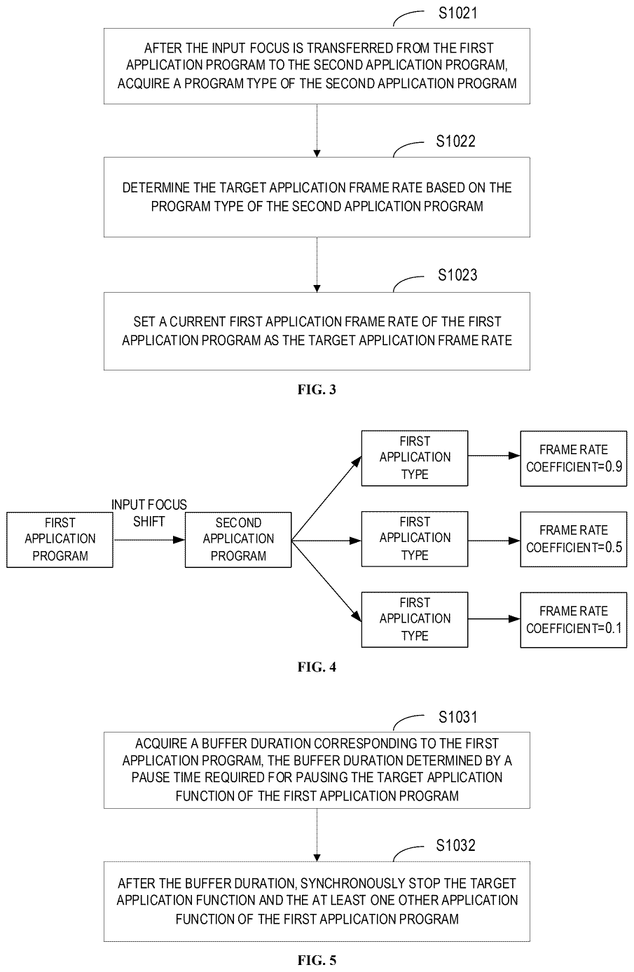

In one possible implementation, as shown in FIG. 3, a specific implementation manner of step S102 includes the following.

At step S1021, a program type of a second application program is acquired after an input focus is transferred from a first application program to the second application program.

At step S1022, determining the target application frame rate is determined based on the program type of the second application program.

At step S1023, a current first application frame rate of the first application program is set as the target application frame rate.

By way of example, an input focus being transferred from a first application program to a second application program is a result of a switching operation received by a terminal device and in response to a user input, and it represents a change of an operation target by the user. In an application scenario where a plurality of application programs run coordinately, a user needs to use a plurality of application programs by switching. After the first application program is switched to the second application program, the lower the target application frame rate set for the first application program is, the less the resource consumption of the first application program is, and the more redundant computing resources reserved for the second application program to use is. However, after the redundant computing resources exceed the computing resources required for running the second application program, the smoothness of the second application program cannot be further improved. Meanwhile, when it is required to switch back to the first application program, since the target application frame rate set by the first application program is too low, a problem of the response speed of the first application program being lower is caused.

By way of example, after the input focus is transferred from the first application program to the second application program, the program type of the second application program may be obtained first to determine the amount of computing resources required for running an application program (i.e., a second application program) of the program type; then, the target application frame rate of the first application program is determined based on the difference between the total computing resource amount of the terminal device and the required computing resource amount. FIG. 4 is a schematic diagram of a process for determining a target application frame rate according to an embodiment of the present disclosure. As shown in FIG. 4, after the input focus is transferred, a program type of a second application program is determined; and when the second application program is of a first program type, it is determined that the frame rate coefficient is 0.9. Specifically, the representation of the first program type includes an application program with computing resources required for running being less than a first preset value, such as a tablet writing program, a drawing board program, a calculator program and a picture viewer program, a frame rate coefficient being equivalent to 0.9 indicates that the target application frame rate of the first application program is 90% of the current application frame rate of the first application program. Similarly, when the second application program is of a second program type, it is determined that the frame rate coefficient is 0.5. Specifically, the representation of the second program type includes an application program with calculation resources required for running being greater than a first preset value but less than a second preset value, such as a browser program and an instant messaging program, and the frame rate coefficient being equivalent to 0.5 represents that the target application frame rate of the first application program is 50% of the current application frame rate of the first application program. When the second application program is of a third program type, it is determined that the frame rate coefficient is 0.1. Specifically, the representation of the third program type includes an application program with calculation resources required for running being greater than a second preset value, such as a large-scale image editing program and a large-scale music editing program, and the frame rate coefficient being equivalent to 0.1 represents that the target application frame rate of the first application program is 10% of the current application frame rate of the first application program.

The computing resources in this embodiment may include one or more of memory resources, central processing unit (CPU) resources, thread resources, cache resources, graphics processing unit (GPU) resources, and hard disk resources, which are not specifically limited.

In this embodiment, a program type of a second application program that receives an input focus is determined, a target computing resource amount required for running the second application program is determined according to the program type of the second application program, and then a target application frame rate of the first application program is determined. In this way, while ensuring that the computational resources reserved for the second application program are sufficient, the target application frame rate of the first application program is increased, and when the first application program needs to be switched back subsequently, the response speed of the first application program is increased, thereby improving overall smoothness of a process in which the first application program and the second application program are switched.

Optionally, the first application program has at least one application function, and the method further includes after the input focus is transferred from the first application program to the second application program:
Step S103: at least one application function of the first application program is stopped, the application function including a video playing function and/or an audio playing function.

By way of example, the first application program has at least one application function, for example, including a video playing function and an audio playing function, for example, it may be functions as video preview and audio preview in a video editing process in an application scenario of the video editing application program. In the prior art, an application function, such as video playing and audio playing, continues to run even if the first application program is in an inactive state (in which input focus is lost), resulting in occupying more computing resources. In this embodiment, when the first application program is in a non-editing state, the video playing function and/or the audio playing function are stopped, which may further reduce resource occupation of the first application program and reduce waste of computing resources. Certainly, it can be understood that, in addition to a video playing function and/or an audio playing function, other continuously running functions, such as video captions, may also be stopped, which is not described herein again.

Further, by way of example, the first application program has a target application function and at least one other application function. As shown in FIG. 5, a specific implementation manner of step S103 includes:

At step S1031, a buffer duration corresponding to the first application program is acquired, where the buffer duration is determined by a pause time required for pausing the target application function of the first application program.

At step S1032, after the buffer duration, the target application function and the at least one other application function of the first application program are synchronously stopped.

By way of example, the first application program has a plurality of application programs including a target application function and at least one other application function other than the target application function. Specifically, for example, the target application function is a video playing function, and for an image editing application program, the target application function is a video preview function, and other application functions may be, for example, audio playing, video subtitle displaying, and the like. In a practical application process, the pause time required for pausing the above application function is different, for example, for a target application function, the pause time required for pausing the target application function needs to be longer, for example, 0.5 seconds. However, pausing other application functions requires a short pause time, for example, 0.02 seconds, that is, an application function with a long pause time may be determined as the target application function. The pause time is a preset value corresponding to each application function, and may be obtained by reading a corresponding configuration file or preset information, which is not described in detail herein again. Further, the difference in the pause time of the foregoing application function is caused by a specific implementation process of the application function. For example, for a video playing function (a video preview function), in the process of playing a video, the video needs to be decoded, then the decoded video frames are displayed frame by frame. FIG. 6 is a schematic diagram of a video playing process according to an embodiment of the present disclosure, the video decoding process and the video frame playing process are performed asynchronously (i.e., the decoding time is inconsistent with the playing time). As shown in FIG. 6, based on a time axis for playing a target video, video decoding is performed first, and a video frame playing is performed later. In order to ensure that no frame skipping occurs, in a common video playing scenario, the decoded video frames (regarded as frames to be played in the drawing) that has not been played are continuously played after the video is paused. As a result, a phenomenon of “delay of pause” occurs on the display of the application program. When the video playing is resumed subsequently, the decoding and playing are restarted from the decoding time, so as to avoid frame skipping due to the loss of the decoded but unplayed video frame. However, in an application scenario corresponding to this embodiment, it needs to be ensured that a plurality of application functions of the first application programs are synchronous, such as, a video preview function (a video playing function), an audio preview function (an audio playing function), and a subtitle display function. That is, when the first application program previews a segment of edited video, it needs to ensure that the video image, audio, and the subtitles corresponding to the segment of edited video are synchronous. Therefore, when each application function of the first application program is paused, a buffer duration is determined based on a duration required for pausing the target application program, and after the buffer duration, the target application function and at least one other application function of the first application program are synchronously stopped.

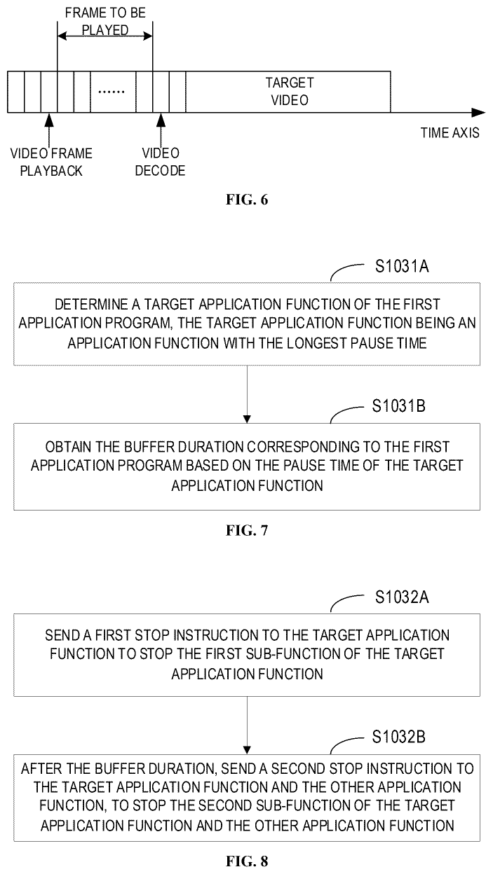

FIG. 7 is a flowchart of a specific implementation of step S1031 in the embodiment shown in FIG. 5. As shown in FIG. 7, for example, the step S1041 specifically includes:

At step S1031A, a target application function of the first application program is determined, where the target application function is an application function having the longest pause time.

At step S1031B, the buffer duration corresponding to the first application program is obtained based on the pause time of the target application function.

Firstly, among all the application functions currently running in the first application program, according to the pause time of each application function, the application function with the longest pause time is determined as the target application function, where the pause time corresponding to each application function is a preset value, and the specific acquisition method thereof will not be described again. Then, based on the pause time of the target application function, a buffer duration corresponding to the first application program is determined, By way of example, a target application function is implemented based on a first sub-function and a second sub-function that are executed in sequence, where the first sub-function is a background processing function, and the second sub-function is a foreground display function. FIG. 8 is a flowchart of a specific implementation of step S1032 in the embodiment shown in FIG. 5. As shown in FIG. 8, by way of example, the specific steps of step S1032 include:

At step S1032A, a first stop instruction is sent to a target application function to stop the first sub-function of the target application function.

At step S1032B, after a buffer duration, a second stop instruction is sent to the target application function and the other application functions to stop the second sub-function of the target application function and other application functions.

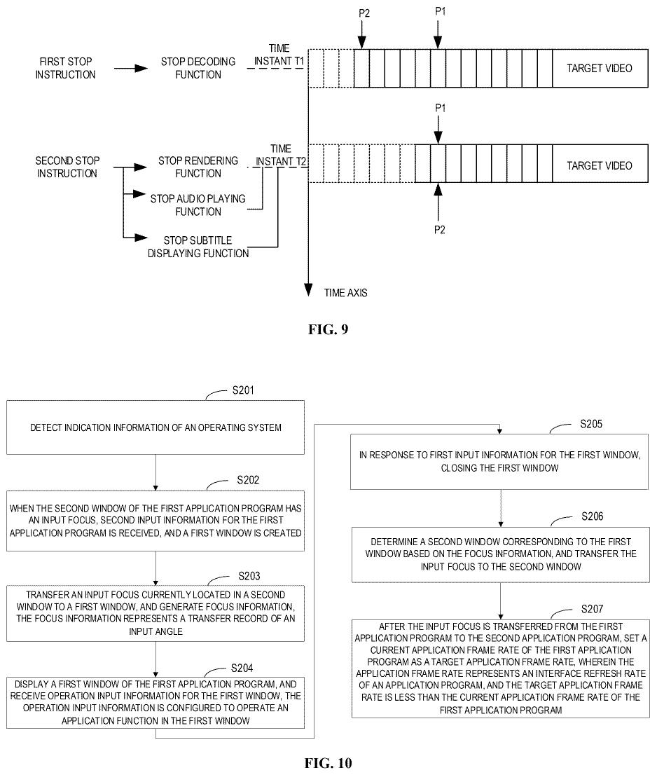

By way of example, taking a video playing function as an example, the video playing function is implemented based on a decoding function (a first sub-function) and a rendering function (a second sub-function) that are executed in sequence. The decoding function is a background processing function, where the background processing function refers to a function that is not displayed at the front end of the application program interface. The rendering function is a foreground display function, and correspondingly, the foreground display function refers to a function of displaying at the front end of the application program interface. FIG. 9 is a schematic diagram of a process of pausing an application function according to an embodiment of the present disclosure. By way of example, in a process in which the terminal device pauses the target application function and the at least one other application function, firstly, a first stop instruction is sent to a target application function, and a first sub-function is stopped, e. g. a decoding function is stopped, that is, new video frames to be played are not generated any more. In this case, referring to the time axis shown in FIG. 9, at the time T1 when the first stop instruction is sent to the target application function, the decoding position P1 and the playing position P2 in the target video are as shown in FIG. 9, and there are several video frames to be played therebetween. Then, after the buffer duration, at a time T2, a second stop instruction is sent to the target application function and other application functions, at this time, the video frames to be played are almost consumed by the second sub-function (rendering function), and the decoding position P1 and the playing position P2 in the target video are as shown in FIG. 9. The two are (almost) overlapped, and at this time, the second sub-function and other application functions are stopped. Since the pause time of other application functions (such as an audio playing function and a subtitle display function) is short, instant stopping can be realized, and therefore, synchronous pausing of a plurality of application functions of the first application program is realized (simultaneously stopping at P2 moment), thereby improving synchronization between the plurality of application functions.

In this embodiment, indication information of an operating system is detected, a first application program and a second application program run in the operating system, and the indication information is configured for indicating an input focus for receiving input information; after an input focus is transferred from a first application program to a second application program, a current application frame rate of the first application program is set as a target application frame rate based on the indication information, where the application frame rate represents an interface refresh rate of the application program, and the target application frame rate is less than the current application frame rate of the first application program. After it is detected that the input focus of the operating system is transferred from the first application program to the second application program, a running parameter of a first application program is configured, so that the first application program runs at a target application frame rate lower than a current application frame rate. In this way, computing resources occupied by the first application program are released, so that the second application program can run by using more sufficient computing resources, thereby improving the smoothness and running speed of a second application program, and reducing the program lagging.

Referring to FIG. 10, FIG. 10 is a second schematic flowchart of a method for controlling running of an application program according to an embodiment of the present disclosure. On the basis of the embodiment shown in FIG. 2, this embodiment adds a step of controlling an input focus within a first application program. The method for controlling running of an application program includes:
At step S201, indication information of an operating system is detected.

At step S202, in a case that the second window of the first application program has an input focus, second input information for the first application program is received, and a first window is created.

At step S203, an input focus currently located in a second window is transferred to a first window, and focus information is generated, where the focus information represents a transfer record of an input angle.

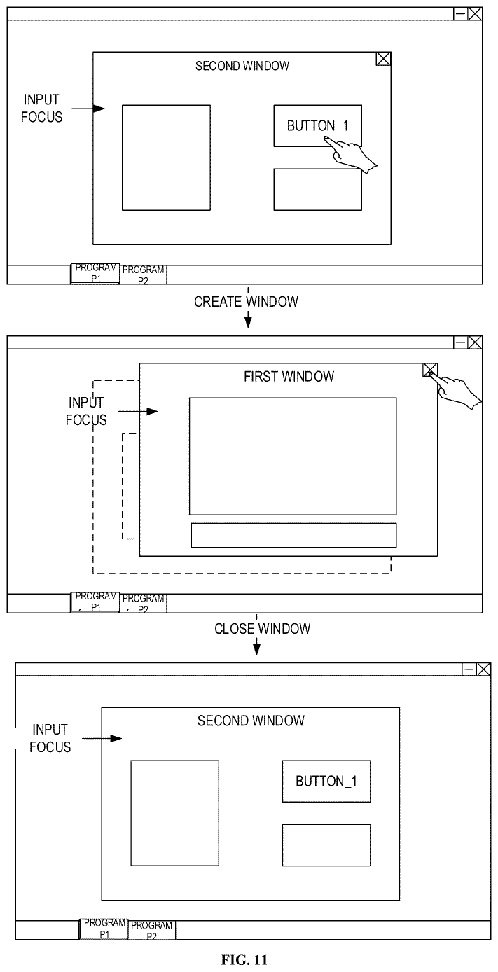

By way of example, one or more windows may be created, opened and closed in a first application program. FIG. 11 is a schematic diagram of creating a first window according to an embodiment of the present disclosure. As shown in FIG. 11, by way of example, in a case that the input focus is located in the second window in the first application program (shown as program P1 in the drawing), the second window is an “active window”, and the second window can receive input information input by a user, i.e., second input information. More specifically, the second input information is, for example, a triggering instruction (illustrated as a hand-shaped identifier) for the component button_1. The terminal device, in response to the second input information, triggers the component button_1, and creates a new function window in the first application program, i.e., the first window. Then, the input focus is transferred from the second window to the first window, and since the first window is created on the basis of the second window and the input focus is also transferred from the second window to the first window, the second window is equivalent to the parent window of the first window. After transferring an input focus currently located in a second window to a first window, and a transfer record representing a transfer relationship between the first window and the second window (i.e., focus information) is generated.

Further, if on the basis of the first window, the terminal device receives the third input information and creates a third window in response to the third input information, the first window is a parent window of the third window. Then, the focus information is further updated, so that the focus information can represent a transfer record of the input focus transferring sequentially according to the order of the second window-the first window-the third window.

At step S204, a first window of the first application program is displayed, and operation input information for the first window is received, where the operation input information is configured to operate an application function in the first window.

By way of example, after a first window is created and the input focus is transferred from the second window to the first window, the first window serves as a current “active window”, and may receive operation input information input by a user to execute an application function in the first window, for example, the first window is used for video preview, and in response to the operation input information, functions such as video skipping and video playback speed setting are implemented, which will not be detailed. It should be noted that this step is an optional step, and the specific implementation for receiving and responding to the operation input information of the first window may be set as needed; a plurality of operations (receiving a plurality of operation input instructions) can be executed after a first window of a first application program is displayed, or in a case that no operation is performed (the operation input instruction is not accepted), the first window is closed. In this process, the input focus is always in the first window of the first application program, and the step of reducing the application frame rate is not triggered.

At step S205, the first window is closed in response to the first input information for the first window.

At step S206, a second window corresponding to the first window is determined based on the focus information, and the input focus is transferred to the second window.

By way of example, according to a requirement, after the execution of a related application function in the first window is completed, the user inputs first input information to close the first window. As shown in FIG. 11, the first input information is, for example, a trigger instruction (a hand-shaped identifier is shown in the drawing) for a window close button, and the terminal device closes the first window in response to the first input information. After that, the input focus of the first window needs to be controlled so that the input focus returns to the parent window of the first window without leaving the first application program, thereby causing the problem of mistakenly triggering the decrease of the application frame rate. Specifically, the focus information generated in the previous step is acquired, the focus information records a transfer record of input focus when the first window is generated, and by means of the focus information, the parent window of the first window, i.e., the second window in the previous step, can be determined. In a possible implementation, a window pointer of the parent window corresponding to the first window is recorded in the focus information, and a corresponding second window can be quickly determined by reading the window pointer.

Further, after determining the second window, the input focus is transferred from the first window to the second window after or while closing the first window, and the second window becomes an “active window”, thus realizing a level-by-level backtracking of the input focus, and after the current active window is closed, the input focus can be transferred in sequence according to the generation order of the functional windows in the first application program, so that the input focus is always located in the first application program, thereby avoiding problem of disappearance of the input focus caused by opening and closing a window in the first application program (which may lead to reduction of the application frame rate by fault).

At step S207, after the input focus is transferred from the first application program to the second application program, a current application frame rate of the first application program is set as a target application frame rate, where the application frame rate represents an interface refresh rate of an application program, and the target application frame rate is less than the current application frame rate of the first application program.

In this embodiment, step S201 and step S207 are consistent with step S101 and step S102 in the foregoing embodiment, and for detailed discussion, reference is made to the discussion of step S101 and step S102 in the embodiment shown in FIG. 2, which is not described herein again.

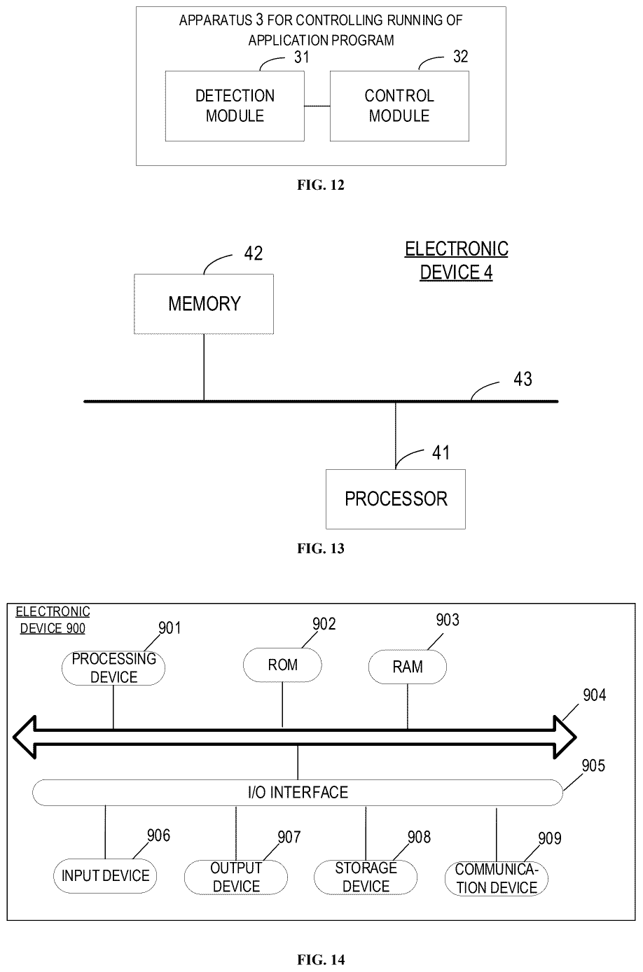

Corresponding to the method for controlling running of an application program in the foregoing embodiments, FIG. 12 is a structural block diagram of an apparatus for controlling running of an application program according to an embodiment of the present disclosure. For ease of description, only parts related to the embodiments of the present disclosure are shown. Referring to FIG. 12, the apparatus for controlling running of an application program 3 includes:
a detection module 31 configured to detect indication information of an operating system, a first application program and a second application program running within the operating system, and the indication information indicating an input focus for receiving input information; and
a control module 32 configured to set a current application frame rate of the first application program as a target application frame rate based on the indication information, after the input focus is transferred from the first application program to the second application program, where the application frame rate represents an interface refresh rate of an application program, and the target application frame rate is less than the current application frame rate of the first application program.

In one embodiment of the present disclosure, the control module 32 is specifically configured to acquire a program type of the second application program after the input focus is transferred from the first application program to the second application program; and determine the target application frame rate based on the program type of the second application program; and set a current first application frame rate of the first application program as the target application frame rate.

In an embodiment of the present disclosure, the first application program has at least one application function, and the control module 32 is further configured to stop, after the input focus is transferred from the first application program to the second application program, at least one application function of the first application program, the application function including a video playing function and/or an audio playing function.

In an embodiment of the present disclosure, the first application program has a target application function and at least one other application function; and the control module 32 is specifically configured to acquire, when at least one application function of the first application program is stopped, a buffer duration corresponding to the first application program, the buffer duration being determined by a pause time required for pausing the target application function of the first application program; and after the buffer duration, synchronously stop the target application function and the at least one other application function of the first application program.

In an embodiment of the present disclosure, when acquiring the buffer duration corresponding to the first application program, the control module 32 is specifically configured to determine a target application function of the first application program, the target application function being an application function with the longest pause time; and obtain, based on the pause time of the target application function, the buffer duration corresponding to the first application program.

In one embodiment of the present disclosure, a target application function is implemented based on a first sub-function and a second sub-function executed in sequence, where the first sub-function is a background processing function, and the second sub-function is a foreground display function. After the buffer duration, when synchronously stopping the target application function and the at least one other application function of the first application program, the control module 32 is specifically configured to: send a first stop instruction to the target application function to stop the first sub-function of the target application function; and after the buffer duration, send a second stop instruction to the target application function and other application functions to stop the second sub-function of the target application function and other application functions.

In one embodiment of the present disclosure, the detection module 31 is further configured to: display a first window of the first application program, the input focus being located within the first window; in response to first input information for the first window, close the first window, and transfer the input focus to a second window of the first application program, where the second window is an superior window of the first window, and the superior window is a window outputting the input focus.

In one embodiment of the present disclosure, the detection module 31 is further configured to: before displaying the first window of the first application program, create a first window in response to second input information for the first application program; transfer the input focus currently located in the second window to the first window, and generate focus information, where the focus information represents a transfer record of the input angle. When transferring the input focus to the second window of the first application program, the detection module 31 is specifically configured to determine the second window corresponding to the first window based on the focus information; and transfer the input focus to the second window.

The detection module 31 is connected to the control module 32. The apparatus for controlling running of an application program 3 provided in this embodiment can execute the technical solution of the foregoing method embodiment. The implementation principle and technical effect are similar, and are not repeatedly described herein in this embodiment.

FIG. 13 is a schematic structural diagram of an electronic device according to an embodiment of the present disclosure. As shown in FIG. 13, the electronic device 4 includes:
a processor 41, and a memory 42 communicatively connected to the processor 41;
the memory 42 stores a computer execution instruction;
the processor 41 executes the computer execution instruction stored in the memory 42, so as to implement the method for controlling running of an application program in the embodiments shown in FIG. 2 to FIG. 7.

Optionally, the processor 41 and the memory 42 are connected by using a bus 43.

The related descriptions can be understood with reference to the related descriptions and effects corresponding to the steps in the embodiments corresponding to FIG. 2 to FIG. 7, and are not repeated herein.

Referring to FIG. 14, it illustrates a schematic structural diagram of an electronic device 900 suitable for implementing an embodiment of the present disclosure. The electronic device 900 may be a terminal device or a server. The terminal device may include, but is not limited to, a mobile terminal such as a mobile phone, a laptop computer, a digital broadcast receiver, a personal digital assistant (Personal Digital Assistant, PDA for short), a tablet computer (Portable Android Device, PAD for short), a portable multimedia player (Portable Media Player, PMP for short), a vehicle-mounted terminal (for example, a vehicle-mounted navigation terminal), and the like, and a fixed terminal such as a digital TV, a desktop computer, and the like. The electronic device shown in FIG. 14 is merely an example and should not bring any limitation to the functions and scope of use of the embodiments of the present disclosure.

As shown in FIG. 14, the electronic device 900 may include a processing device (e. g., central processing unit, graphics processor, etc.) 901 that may perform various suitable actions and processes in accordance with a program stored in a read only memory (ROM) 902 or a program loaded into a random access memory (RAM) 903 from a storage device 908. In the RAM 903, various programs and data necessary for the operation of the electronic apparatus 900 are also stored. The processing devices 901, the ROM 902, and the RAM 903 are connected to each other via a bus 904. An input/output (I/O) interface 905 is also connected to the bus 904.

In general, the following devices may be connected to the I/O interface 905: an input device 906 including, for example, a touch screen, touch pad, keyboard, mouse, camera, microphone, accelerometer, gyroscope, or the like; an output device 907 including, for example, a liquid crystal display (LCD), a speaker, a vibrator, or the like; a storage device 908 including, for example, a magnetic tape, a hard disk, or the like; and a communication device 909. The communication device 909 may allow the electronic device 900 to communicate wirelessly or with other devices to exchange data. While FIG. 14 illustrates the electronic device 900 with a variety of devices, it should be understood that it is not required that all of the illustrated devices be implemented or provided. More or fewer devices may alternatively be implemented or provided.

In particular, the processes described above with reference to the flowcharts can be implemented as computer software programs, in accordance with embodiments of the present disclosure. For example, embodiments of the present disclosure include a computer program product including a computer program carried on a computer readable medium. The computer program includes a program code for executing the method as shown in the flowchart. In such an embodiment, the computer program may be downloaded and installed from the network via communications device 909, installed from storage 908, or installed from ROM 902. When the computer program is executed by the processing device 901, the above-described functions defined in the method according to the embodiment of the present disclosure are executed.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium (other than the computer readable storage medium) that can communicate, propagate, or transport a program for use by or in connection with an instruction execution system, apparatus, or device. Program code embodied on a computer readable medium may be transmitted using any appropriate medium, including, but not limited to, wireline, optical fiber cable, RF (radio frequency), etc., or any suitable combination of the foregoing.

The computer readable medium may be included in the electronic device, or may exist separately and not be installed in the electronic device.

The computer readable medium carries one or more programs thereon, and when the one or more programs are executed by the electronic device, the electronic device is enabled to execute the method shown in the foregoing embodiments.

Computer program codes for performing the operations of the present disclosure may be written in one or more programming languages or a combination thereof, including but not limited to Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN) or wide area network (WAN)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first acquiring unit may also be described as “a unit for acquiring at least two internet protocol addresses”.

The functions described herein above can be performed at least in part by one or more hardware logic components. For example, without limitation, example types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

In a first aspect, according to one or more embodiments of the present disclosure, a method for controlling running of an application program is provided, including:
detecting indication information of an operating system, a first application program and a second application program running within the operating system, and the indication information indicating an input focus for receiving input information; and after the input focus is transferred from the first application program to the second application program, setting a current application frame rate of the first application program as a target application frame rate based on the indication information, where the application frame rate represents an interface refresh rate of an application program, and the target application frame rate is less than the current application frame rate of the first application program.

According to one or more embodiments of the present disclosure, setting the current application frame rate of the first application program as the target application frame rate includes: acquiring a program type of the second application program; determining the target application frame rate based on the program type of the second application program; and setting a current first application frame rate of the first application program as the target application frame rate.

According to one or more embodiments of the present disclosure, the first application program has at least one application function; and the method further includes after the input focus is transferred from the first application program to the second application program, stopping the at least one application function of the first application program, the application function including a video playing function and/or an audio playing function.

According to one or more embodiments of the present disclosure, the first application program has a target application function and at least one other application function, and stopping the at least one application function of the first application program includes: acquiring a buffer duration corresponding to the first application program, the buffer duration being determined by a pause time required for pausing the target application function of the first application program; and after the buffer duration, synchronously stopping the target application function and the at least one other application function of the first application program.

According to one or more embodiments of the present disclosure, acquiring the buffer duration corresponding to the first application program includes: determining a target application function of the first application program, the target application function being an application function with the longest pause time; and obtaining, based on the pause time of the target application function, the buffer duration corresponding to the first application program.

According to one or more embodiments of the present disclosure, the target application function is implemented based on a first sub-function and a second sub-function executed in sequence, where the first sub-function is a background processing function, and the second sub-function is a foreground display function; synchronously stopping the target application function and the at least one other application function of the first application program after the buffer duration including: sending a first stop instruction to the target application function to stop the first sub-function of the target application function; after the buffer duration, sending a second stop instruction to the target application function and the other application function, to stop the second sub-function of the target application function and the other application function.

According to one or more embodiments of the present disclosure, the method further includes: displaying a first window of the first application program, the input focus being located within the first window; and in response to first input information for the first window, closing the first window, and transferring the input focus to a second window of the first application program, where the second window is a superior window of the first window, and the superior window is a window outputting the input focus.

According to one or more embodiments of the present disclosure, the method further includes, before displaying the first window of the first application program: in response to second input information for the first application program, creating the first window; transferring the input focus currently located in the second window to the first window, and generating focus information, the focus information representing a transfer record of the input angle; and transferring the input focus to the second window of the first application program including: determining the second window corresponding to the first window based on the focus information; and transferring the input focus to the second window.

In a second aspect, according to one or more embodiments of the present disclosure, an application running control apparatus is provided, including:
a detection module configured to detect indication information of an operating system, a first application program and a second application program running within the operating system, and the indication information indicating an input focus for receiving input information; and
a control module configured to set a current application frame rate of the first application program as a target application frame rate based on the indication information, after the input focus is transferred from the first application program to the second application program, where the application frame rate represents an interface refresh rate of an application program, and the target application frame rate is less than the current application frame rate of the first application program.

According to one or more embodiments of the present disclosure, the control module is specifically configured to: acquire a program type of the second application program after the input focus is transferred from the first application program to the second application program; determine the target application frame rate based on the program type of the second application program; and set a current first application frame rate of the first application program as the target application frame rate.

According to one or more embodiments of the present disclosure, the first application program has at least one application function, and the control module is further configured to stop, after the input focus is transferred from the first application program to the second application program, at least one the application function of the first application program, where the application function includes a video playing function and/or an audio playing function.

According to one or more embodiments of the present disclosure, the first application program has a target application function and at least one other application function, and the control module is specifically configured to acquire a buffer duration corresponding to the first application program when stopping the at least one application function of the first application program, the buffer duration being determined by a pause time required for pausing the target application function of the first application program; after the buffer duration, synchronously stopped the target application function and the at least one other application function of the first application program.

According to one or more embodiments of the present disclosure, when acquiring the buffer duration corresponding to the first application program, the control module is specifically configured to: determine a target application function of the first application program, the target application function being an application function with the longest pause time; and obtain, based on the pause time of the target application function, the buffer duration corresponding to the first application program.

According to one or more embodiments of the present disclosure, the target application function is implemented based on a first sub-function and a second sub-function executed in sequence, where the first sub-function is a background processing function, and the second sub-function is a foreground display function. After the buffer duration, when the control module synchronously stops a target application function of the first application program and at least one other application function, the control module is specifically configured to: send a first stop instruction to the target application function to stop the first sub-function of the target application function; and after the buffer duration, send a second stop instruction to the target application function and the other application function, to stop the second sub-function of the target application function and the other application function.

According to one or more embodiments of the present disclosure, the detection module is further configured to display a first window of the first application program, where the input focus is located inside the first window; close the first window in response to first input information for the first window, and transfer the input focus to a second window of the first application program, where the second window is a superior window of the first window, and the superior window is a window outputting the input focus.

According to one or more embodiments of the present disclosure, before displaying the first window of the first application program, the detection module is further configured to: create the first window in response to second input information for the first application program; transfer the input focus currently located in the second window to the first window, and generate focus information, the focus information representing a transfer record of the input angle; and when the detection module transfers the input focus to the second window of the first application program, the detection module is specifically configured to: determine, the second window corresponding to the first window based on the focus information; and transferring the input focus to the second window.

In a third aspect, according to one or more embodiments of the present disclosure, there is provided an electronic device, including: a processor and a memory in communication connection with the processor;
the memory stores computer execution instructions;
the processor executes the computer execution instructions stored in the memory, so as to implement the method for controlling running of an application program according to the foregoing first aspect and various possible designs of the first aspect.

In a fourth aspect, according to one or more embodiments of the present disclosure, a computer readable storage medium is provided. The computer readable storage medium stores computer execution instructions. When executing the computer execution instructions, a processor implements the method for controlling running of an application program according to the first aspect and various possible designs of the first aspect is implemented.

According to a fifth aspect, an embodiment of the present disclosure provides a computer program product, including a computer program. When being executed by a processor, the computer program implements the method for controlling running of an application program according to the foregoing first aspect and various possible designs of the first aspect.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations is depicted in a specific order, this should not be understood as requiring these operations to be performed in the specific order shown or in a sequential order. In certain environments, multitasking and parallel processing may be advantageous. Similarly, although a plurality of implementation details is included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

1-12. (canceled)

13. A method for controlling running of application program, comprising:
detecting indication information of an operating system, a first application program and a second application program running within the operating system, the indication information indicating an input focus for receiving input information; and
after the input focus is transferred from the first application program to the second application program, setting a current application frame rate of the first application program as a target application frame rate based on the indication information, wherein the application frame rate represents an interface refresh rate of an application program, and the target application frame rate is less than the current application frame rate of the first application program.

14. The method according to claim 13, wherein setting the current application frame rate of the first application program as the target application frame rate comprises:
acquiring a program type of the second application program;
determining the target application frame rate based on the program type of the second application program; and
setting a current first application frame rate of the first application program as the target application frame rate.

15. The method according to claim 13, wherein the first application program has at least one application function, and the method further comprises after the input focus is transferred from the first application program to the second application program,
stopping the at least one application function of the first application program, the application function comprising a video playing function and/or an audio playing function.

16. The method according to claim 15, wherein the first application program has a target application function and at least one other application function, and stopping the at least one application function of the first application program comprises:
acquiring a buffer duration corresponding to the first application program, the buffer duration determined by a pause time required for pausing the target application function of the first application program; and
after the buffer duration, synchronously stopping the target application function and the at least one other application function of the first application program.

17. The method according to claim 16, wherein acquiring the buffer duration corresponding to the first application program comprises:
determining a target application function of the first application program, the target application function being an application function with the longest pause time; and
obtaining, based on the pause time of the target application function, the buffer duration corresponding to the first application program.

18. The method according to claim 16, wherein the target application function is implemented based on a first sub-function and a second sub-function executed in sequence, wherein the first sub-function is a background processing function, and the second sub-function is a foreground display function;
synchronously stopping the target application function and the at least one other application function of the first application program after the buffer duration comprises:
sending a first stop instruction to the target application function to stop the first sub-function of the target application function; and
after the buffer duration, sending a second stop instruction to the target application function and the other application function, to stop the second sub-function of the target application function and the other application function.

19. The method according to claim 13, further comprising:
displaying a first window of the first application program, the input focus located within the first window; and
in response to first input information for the first window, closing the first window, and transferring the input focus to a second window of the first application program, wherein the second window is a superior window of the first window, and the superior window is a window outputting the input focus.

20. The method according to claim 19, wherein before displaying the first window of the first application program, the method further comprises:
in response to second input information for the first application program, creating the first window;
transferring the input focus currently located in the second window to the first window, and generating focus information, the focus information representing a transfer record of the input focus; and
transferring the input focus to the second window of the first application program comprising:
determining the second window corresponding to the first window based on the focus information; and
transferring the input focus to the second window.

21. An electronic device, comprising: a processor, and a memory communicatively connected to the processor;
the memory storing computer execution instructions;
the processor executing the computer execution instructions stored in the memory, to implement acts comprising:
detecting indication information of an operating system, a first application program and a second application program running within the operating system, the indication information indicating an input focus for receiving input information;
after the input focus is transferred from the first application program to the second application program, setting a current application frame rate of the first application program as a target application frame rate based on the indication information, wherein the application frame rate represents an interface refresh rate of an application program, and the target application frame rate is less than the current application frame rate of the first application program.

22. The electronic device according to claim 21, wherein setting the current application frame rate of the first application program as the target application frame rate comprises:
acquiring a program type of the second application program;
determining the target application frame rate based on the program type of the second application program; and
setting a current first application frame rate of the first application program as the target application frame rate.

23. The electronic device according to claim 21, wherein the first application program has at least one application function, and the acts further comprise after the input focus is transferred from the first application program to the second application program,
stopping the at least one application function of the first application program, the application function comprising a video playing function and/or an audio playing function.

24. The electronic device according to claim 23, wherein the first application program has a target application function and at least one other application function, and stopping the at least one application function of the first application program comprises:
acquiring a buffer duration corresponding to the first application program, the buffer duration determined by a pause time required for pausing the target application function of the first application program;
after the buffer duration, synchronously stopping the target application function and the at least one other application function of the first application program.

25. The electronic device according to claim 24, wherein acquiring the buffer duration corresponding to the first application program comprises:
determining a target application function of the first application program, the target application function being an application function with the longest pause time;
obtaining, based on the pause time of the target application function, the buffer duration corresponding to the first application program.

26. The electronic device according to claim 24, wherein the target application function is implemented based on a first sub-function and a second sub-function executed in sequence, wherein the first sub-function is a background processing function, and the second sub-function is a foreground display function;
synchronously stopping the target application function and the at least one other application function of the first application program after the buffer duration comprises:
sending a first stop instruction to the target application function to stop the first sub-function of the target application function;
after the buffer duration, sending a second stop instruction to the target application function and the other application function, to stop the second sub-function of the target application function and the other application function.

27. The electronic device according to claim 21, further comprising:
displaying a first window of the first application program, the input focus located within the first window;
in response to first input information for the first window, closing the first window, and transferring the input focus to a second window of the first application program, wherein the second window is a superior window of the first window, and the superior window is a window outputting the input focus.

28. The electronic device according to claim 27, wherein before displaying the first window of the first application program, the acts further comprise:
in response to second input information for the first application program, creating the first window;
transferring the input focus currently located in the second window to the first window, and generating focus information, the focus information representing a transfer record of the input focus; and
transferring the input focus to the second window of the first application program comprising:
determining the second window corresponding to the first window based on the focus information; and
transferring the input focus to the second window.

29. A non-transitory computer readable storage medium having computer execution instructions stored therein, a processor, when executing the computer execution instructions, implementing acts comprising:
detecting indication information of an operating system, a first application program and a second application program running within the operating system, the indication information indicating an input focus for receiving input information;
after the input focus is transferred from the first application program to the second application program, setting a current application frame rate of the first application program as a target application frame rate based on the indication information, wherein the application frame rate represents an interface refresh rate of an application program, and the target application frame rate is less than the current application frame rate of the first application program.

30. A computer program product comprising a computer program which, when executed by a processor, implementing acts comprising:
detecting indication information of an operating system, a first application program and a second application program running within the operating system, the indication information indicating an input focus for receiving input information;
after the input focus is transferred from the first application program to the second application program, setting a current application frame rate of the first application program as a target application frame rate based on the indication information, wherein the application frame rate represents an interface refresh rate of an application program, and the target application frame rate is less than the current application frame rate of the first application program.
